(19) United States
(12) Patent Application Publication
(10) Pub. No.: US 2010/0148659 A1
(43) Pub. Date: Jun. 17, 2010

(54) PLASMA DISPLAY PANEL AND METHOD OF MANUFACTURING THE SAME

(75) Inventors: Young-Gill YOO, Suwon-si (KR); Kyeong-Woon Chung, Suwon-si (KR); Jeong-Hyeon Ha, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/629,235

(22) Filed: Dec. 2, 2009

(30) Foreign Application Priority Data
Dec. 16, 2008 (KR) 10-2008-0128202

(51) Int. Cl. H01J 63/04; H01J 9/24

(52) U.S. Cl. 313/487; 445/24

(57) ABSTRACT

A method of manufacturing a plasma display panel (PDP) and a PDP that includes a phosphor layer having a first phosphor and a second phosphor, wherein the first phosphor can be excited by a first radiation having a wavelength of 147±10 nm, a second radiation having a wavelength of 173±10 nm, and a third radiation having a wavelength within the first wavelength range, and the second phosphor has a maximum emission peak in the first wavelength range, and a method of manufacturing the PDP. These improve efficiency of green light emission in order to improve the image quality of a PDP.

### CROSS-REFERENCE TO RELATED APPLICATION

This application claims the benefit of Korean Patent Application No. 10-2008-0128202, filed Dec. 16, 2008 in the Korean Intellectual Property Office, the disclosure of which is incorporated herein by reference.

### BACKGROUND OF THE INVENTION

1. Field of the Invention

Aspects of the present invention relate to a plasma display panel (PDP) and a method of manufacturing the PDP, and more particularly, to a PDP including a phosphor layer having both a first phosphor and a second phosphor, and the second phosphor has a maximum emission peak in the first wavelength range

2. Description of the Related Art

Display devices may be classified as either self-emitting type displays or non self-emitting type displays that use a separate lamp. An example of a non self-emitting type display may include a liquid crystal display (LCD), and examples of self-emitting type displays may include plasma display panels (PDP), cathode ray tubes (CRT), or organic light emitting devices (OLED).

Self-emitting type displays may use a phosphor. Phosphors may be classified as photoluminescent (PL), cathodoluminescent (CL), or electroluminescent (EL). PDPs that are self-emitting type displays use a PL phosphor.

Moreover, in order to realize full color in self-emitting type displays, a three colored light, such as red, green, and blue, is used. Here, green is the most important component of an image from among the three colored lights.

### SUMMARY OF THE INVENTION

Aspects of the present invention provide a plasma display panel (PDP) and a method of manufacturing the PDP for improving efficiency of green light emission, in order to improve the quality of an image in a PDP. An aspect of the present invention provides a plasma display panel (PDP) including: a first substrate and a second substrate facing the first substrate; a phosphor layer disposed in a discharge space interposed between the first substrate and the second substrate; a discharge electrode applying voltage for causing discharge in the discharge space; and discharge gas injected into the discharge space; wherein the phosphor layer comprises a first phosphor and a second phosphor, the first phosphor being excited by a first radiation having a wavelength of 147±10 nm, a second radiation having a wavelength of 173±10 nm, and a third radiation having a wavelength within the first wavelength range, and the second phosphor has a maximum emission peak in the first wavelength range.

Another aspect of the present invention provides a method of manufacturing a plasma display panel (PDP), the method including: forming the phosphor layer comprising a first phosphor, a second phosphor, a binder, and a solvent, wherein the first phosphor is excited by a first radiation having a wavelength of 147±10 nm, a second radiation having a wavelength of 173±10 nm, and a third radiation having a wavelength within the first wavelength range and the second phosphor has a maximum emission peak in the first wavelength range; supplying the composition for forming the phosphor layer into a discharge space interposed between a first substrate and a second substrate; and heat treating the supplied composition for forming the phosphor layer and thus forming a phosphor layer in the discharge space.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective diagram of a plasma display panel (PDP) according to an embodiment of the present invention;

FIGS. 2A and 2B are graphs showing an excitation spectrum of a Y₃Al₅O₁₂:Ce³⁺ green phosphor over various wavelength ranges;

FIG. 3 is a graph showing an emission spectrum of a BaMgAl₁₀O₁₇:Eu blue phosphor; and

FIG. 4 is a graph respectively showing green emission spectra of PDPs manufactured in the Comparative Example and Examples 1 through 4.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

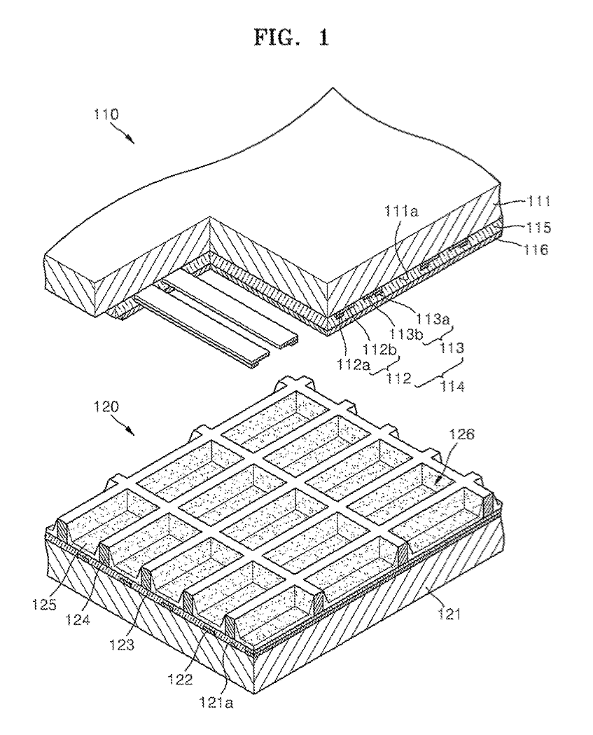

FIG. 1 is a perspective diagram of a plasma display panel (PDP) according to an embodiment of the present invention. Referring to FIG. 1, a first panel 110 includes a first substrate 111, pairs of sustain electrodes 114 including Y-axis electrodes (hereafter, Y electrodes) 112 and X-axis electrodes 113 (hereafter, X electrodes) formed on a rear surface 111A of the first substrate 111, a first dielectric layer 115 covering the pairs of sustain electrodes 114, and a protecting layer 116 covering the first dielectric layer 115. The Y electrodes 112 and the X electrodes 113 include, respectively, transparent electrodes 112B and 113B, formed for example of ITO, and bus electrodes 112A and 113A formed of a metal having excellent conductivity.

A second panel 120 includes a second substrate 121, address electrodes 122 formed on a front surface 121A of the second substrate 121 to cross the pairs of sustain electrodes 114, a second dielectric layer 123 covering the address electrodes 122, and partition walls 124 disposed on the second dielectric layer 123.

When the first panel 110 and the second panel 120 are combined with each other, the lower parts of the partition walls 124 are attached to the second dielectric layer 123 and the upper parts of the partition walls 124 are attached to the first dielectric layer 115. Accordingly, the partition walls 124 create a discharge space interposed between the first substrate 111 and the second substrate 121 so as to form a plurality of discharge cells 126. In the present embodiment, the partition walls 124 are disposed in a matrix form and thus the discharge cells 126 have a rectangular form. Here, discharge electrodes applying voltage for causing discharge in the discharge space may include both the pairs of sustain electrodes 114 and the address electrodes 122.

Within the discharge cells 126, a phosphor layer 125 is formed. The phosphor layer 125 is disposed in the discharge space interposed between the first substrate 111 and the second substrate 121. Discharge gas is injected into the discharge cells 126. The discharge gas may be, for example, an Ne—Xe mixture gas including about 5% to about 10% of Xe. If necessary, at least part of the Ne may be replaced with He.

The phosphor layer 125 includes a first phosphor and a second phosphor, wherein the first phosphor may be excited by a first radiation having a wavelength of 147±10 nm, a second radiation having a wavelength of 173±10 nm, and a third radiation having a wavelength within the first wavelength range, while the second phosphor has a maximum emission peak in the first wavelength range.

Therefore, the first phosphor may be excited by radiation in various wavelength ranges, and thus have excellent excitation efficiency. For example, the first radiation may have a wavelength of 147±10 nm, the second radiation may have a wavelength of 173±10 nm, and the third radiation may have a wavelength within the first wavelength range. Here, the first wavelength range may be 300 nm to 500 nm.

The first phosphor may be a YAG:Ce based green phosphor. More specifically, the first phosphor may be a Y₃Al₅O₁₂:Ce³⁺ green phosphor. The first radiation having a wavelength of 147±10 nm and the second radiation having a wavelength of 173±10 nm, which may excite the first phosphor, may be, for example, vacuum ultraviolet (VUV) having wavelengths of 147±10 nm and of 173±10 nm, and may be emitted while discharging the discharge gas included in a PDP.

The phosphor layer 125 also includes the second phosphor, which has a maximum emission peak in the first wavelength range. Thus, the first phosphor may be efficiently excited by the radiation emitted from the second phosphor.

Accordingly, the first phosphor may be excited by the first radiation and the second radiation (that is, VUV having wavelengths between 147±10 nm and between 173±10 nm), which may be provided from discharging of the discharge gas included in the PDP, so as to emit light. Also, the first phosphor is excited by radiation having the maximum emission peak of the first wavelength range, emitted from the second phosphor included in the phosphor layer 125, so as to emit light. Thus, the phosphor layer 125 may have high light emitting efficiency.

Thus, the second phosphor should emit radiation having a wavelength within the wavelength band of the third radiation, that is, the first wavelength range, so as to excite the first phosphor. Thus according to the present embodiment, the first wavelength range may be 300 nm to 500 nm and therefore the second phosphor may be any blue phosphor, for example.

Although there may be some difference in color purity, light mostly classified as blue has a wavelength of about 380 nm to about 480 nm. For example, the maximum emission peak of the radiation emitted from the second phosphor may be in a range of about 430 nm to about 480 nm but is not limited thereto.

The second phosphor may be a blue phosphor that can emit blue light. Examples of the blue phosphor may include a BAM based phosphor or a CMS based phosphor. However, the second phosphor is not limited thereto. As an example, the second phosphor may be at least one of blue phosphors having a peak wavelength of about 450 nm, including a BaMgAl₁₀O₁₇:Eu blue phosphor, a BaMgAl₁₄O₂₃:Eu blue phosphor, a BaMg₂Al₁₆O₂₇:Eu blue phosphor, or a CaMgSi₂O₆:Eu blue phosphor.

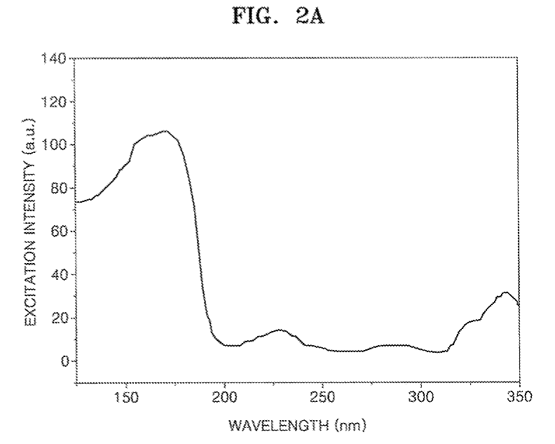

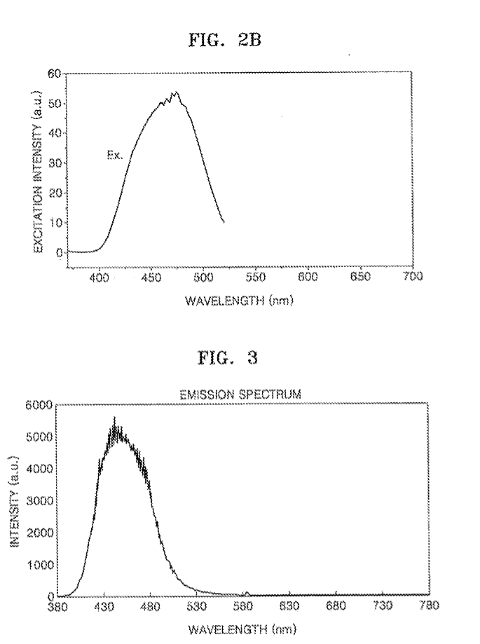

According to the present embodiment, the first phosphor may be a Y₃Al₅O₁₂:Ce³⁺ green phosphor and the second phosphor may be a BaMgAl₁₀O₁₇:Eu blue phosphor. The excitation spectrum of the Y₃Al₅O₁₂:Ce³⁺ green phosphor is illustrated with reference to FIGS. 2A and 2B. The emission spectrum of the BaMgAl₁₀O₁₇:Eu blue phosphor is illustrated with reference to FIG. 3.

Referring to FIGS. 2A and 2B, the Y₃Al₅O₁₂:Ce³⁺ green phosphor may be excited by radiation having a wavelength of about 147 nm and may also be excited by radiation having a wavelength of about 174 nm, respectively. Also, the Y₃Al₅O₁₂:Ce³⁺ green phosphor may be excited by radiation having a wavelength within a range of about 300 nm to about 500 nm. In addition, excitation intensity of the Y₃Al₅O₁₂:Ce³⁺ green phosphor by radiation having a wavelength of about 460 nm is relatively great compared to radiation having other wavelengths within the range of about 300 nm to about 500 nm.

Referring to FIG. 3, the BaMgAl₁₀O₁₇:Eu blue phosphor mostly emits blue light having a wavelength of about 430 nm to about 480 nm. Accordingly, the Y₃Al₅O₁₂:Ce³⁺ green phosphor may be excited by blue light emitted from the BaMgAl₁₀O₁₇:Eu blue phosphor.

The amount of the second phosphor may be 5 parts by weight to 20 parts by weight or, in particular, 10 parts by weight to 15 parts by weight, based on 100 parts by weight of the total amount of the first phosphor and the second phosphor. When the amount of the second phosphor is between 5 parts by weight and 20 parts by weight based on 100 parts by weight of the total amount of the first phosphor and the second phosphor, the quantity of light emitted from the second phosphor may efficiently excite the first phosphor and the amount of light emitted from the second phosphor may be low enough such that green emission may be efficiently accomplished.

The phosphor layer 125 may emit green light. Accordingly, color coordinates of the phosphor layer 125 may be in a green light emission range. For example, the X coordinate may have a range of about 0.334 to about 0.369 and the Y coordinate may have a range of about 0.435 to about 0.458. However, the X coordinate and the Y coordinate are not limited thereto.

The PDP is now described with reference back to FIG. 1. However, the configuration thereof is not limited to FIG. 1 and may vary. A method of manufacturing the PDP may include as follows: for forming the phosphor layer, providing a composition including the first phosphor, the second phosphor, a binder, and a solvent, wherein the first phosphor may be excited by the first radiation having a wavelength of 147±10 nm, the second radiation having a wavelength of 173±10 nm, and the third radiation having a wavelength within the first wavelength range, and the second phosphor has a maximum emission peak in the first wavelength range; placing the composition in the discharge space interposed between the first substrate and the second substrate; and heat treating the composition, thus forming the phosphor layer in the discharge space.

First, the composition for forming the phosphor layer including the first phosphor, the second phosphor, the binder, and the solvent is prepared. The first phosphor and the second phosphor are described as above.

The binder may provide viscosity that is appropriate for the composition and surrounds the phosphors so as to form a flat layer, when the composition for forming the phosphor layer is placed in a predetermined region. The binder may include at least one resin selected from the group consisting of a cellulosic resin and an acrylic resin.

More specifically, examples of the cellulosic resin may include methyl cellulose, ethyl cellulose, propyl cellulose, hydroxymethyl cellulose, hydroxyethyl cellulose, hydroxypropyl cellulose, hydroxyethylpropyl cellulose, or a mixture thereof. Examples of the acrylic resin may include poly(methyl methacrylate), poly(isopropyl methacrylate), poly(isobutyl methacrylate), or a homopolymer or copolymer of an acrylic monomer such as methyl methacrylate, ethyl methacrylate, propyl methacrylate, butyl methacrylate, hexyl methacrylate, 2-ethylhexyl methacrylate, benzyl methacrylate, dimethylaminoethyl methacrylate, hydroxyethyl methacrylate, hydroxypropyl methacrylate, hydroxybutyl methacrylate, phenoxy-2-hydroxypropyl methacrylate, glycidyl methacrylate, methyl acrylate, ethyl acrylate, propyl acrylate, butyl acrylate, hexyl acrylate, 2-ethylhexyl acrylate, benzyl acrylate, dimethylaminoethyl acrylate, hydroxyethyl acrylate, hydroxypropyl acrylate, hydroxybutyl acrylate, phenoxy-2-hydroxypropyl acrylate, or glycidyl acrylate, or a mixture thereof. However, the acrylic resin is not limited thereto.

The amount of the binder may be 4 parts by weight to 25 parts by weight or, in particular, 5 parts by weight to 15 parts by weight, based on 100 parts by weight of the phosphors. When the amount of the binder is above 4 parts by weight based on 100 parts by weight of the phosphors, sufficient viscosity that is appropriate for printing may be obtained. When the amount of the binder is below 25 parts by weight based on 100 parts by weight of the phosphors, remaining carboneous material that originated from the binder after heat treating of the composition may be substantially removed.

The solvent provides fluidity that is appropriate for the composition for forming the phosphor layer, disperses the phosphors, and dissolves the binder. More specifically, examples of the solvent may include at least one compound selected from the group consisting of 2-butoxyethanol, terpineol, butyl carbitol, butyl carbitol acetate, pentane diol, dipentine, limonin, and distilled water. However, the solvent is not limited thereto.

The amount of the solvent may be 90 parts by weight to 250 parts by weight or, in particular, 100 parts by weight to 230 parts by weight, based on 100 parts by weight of the phosphors. When the amount of the solvent is above 90 parts by weight based on 100 parts by weight of the phosphors, dispersibility of the composition for forming the phosphor layer may be sufficiently maintained. When the amount of the solvent is below 250 parts by weight based on 100 parts by weight of the phosphors, viscosity of the composition that is appropriate for forming the phosphor layer may be obtained.

The composition may further include a photo-accelerator such as benzophenone, an antifoaming agent, a dispersant, a plasticizer, a leveling agent, or an antioxidant. The antifoaming agent or the dispersant may include a silicon polyester resin. The plasticizer may include a phthalate based compound, for example, dioctyl phthalate, 2-ethylhexyl phthalate, diisononyl phthalate, dibutyl phthalate, or diisodecyl phthalate. However, the plasticizer is not limited thereto.

The viscosity of the composition for forming the phosphor layer may be 15000 cps to 23000 cps or, in particular, 17000 cps to 21000 cps. When the viscosity of the composition is above 15000 cps, printing ability of the composition may be improved while supplying the composition, and thus a phosphor layer having a minute pattern may be formed.

Then, the composition is placed in a predetermined region of the discharge space interposed between the first substrate and the second substrate. Here, the “first substrate”, “second substrate,” and the “discharge space” denote two substrates included in the PDP and the discharge space formed between the two substrates and are described in more detail with reference to FIG. 1. The “predetermined region of the discharge space interposed between the first substrate and the second substrate” is a region where the phosphor layer is to be formed and is described in more detail with reference to FIG. 1.

The composition may be placed in the discharge space using various well known methods, for example, by a dispenser or by inkjet printing. However, the methods are not limited thereto.

After the composition is placed in the discharge space, the composition is heat treated and the phosphor layer is formed in the discharge space interposed between the first substrate and the second substrate. Here, the heat treatment may be performed under atmospheric conditions. The temperature for the heat treatment may be about 400° C. to about 600° C. or, for example, about 480° C. to about 550° C., and the time for the heat treatment may be about 1 to about 4 hours. Moreover, before the heat treatment, the composition may be previously dried at a temperature in the range of about 150° C. to about 220° C. so that the solvent may be partially removed.

Aspects of the present invention will be described in greater detail with reference to the following examples. The following examples are for illustrative purposes and are not intended to limit the scope of the invention.

### Examples

### Example 1

15 parts by weight of the binder and 150 parts by weight of the solvent, based on a combined 100 parts by weight of a Y₃Al₅O₁₂:Ce³⁺ green phosphor and a BaMgAl₁₀O₁₇:Eu phosphor, were mixed and were stirred using a paste stirrer, thereby completing manufacture of the composition for forming the phosphor layer having a viscosity of about 19000 cps to about 21000 cps. Here, the amount of the BaMgAl₁₀O₁₇:Eu blue phosphor was adjusted to 5 parts by weight, based on a combined 100 parts by weight of the Y₃Al₅O₁₂:Ce³⁺ green phosphor and the BaMgAl₁₀O₁₇:Eu blue phosphor. Ethyl cellulose obtained from Dow Chemical Co. Ltd. was used as the binder. A mixture of terpineol and butyl carbitol acetate, mixed in volume ratio of 7:3, was used as the solvent.

In addition, address electrodes made of copper were formed on a glass substrate having a thickness of 2 mm using photolithography. The address electrodes were coated with PbO glass so as to form a second dielectric layer having a thickness of 20 μm. Then, the composition was placed on the second dielectric layer using a dispenser. Discharge pressure was set to deposit the composition about 100 μm from the second dielectric layer. The composition was then dried at 100° C. for 15 minutes and the temperature was increased in steps of 50° C. and was maintained at each new level for 15 minutes. Then the composition was heat treated at 500° C. for 1 hour and 30 minutes under atmospheric conditions so as to form a phosphor layer, thereby completing manufacture of a second substrate.

Then, bus electrodes made of copper were formed on a glass substrate having a thickness of 2 mm using photolithography. The bus electrodes were coated with PbO glass so as to form a first dielectric layer having a thickness of 20 μm. Then, an MgO protecting layer was formed on the first dielectric layer, thereby completing manufacture of a first substrate.

The second substrate and the first substrate were spaced apart from each other by 130 μm and facing each other, thereby manufacturing a cell. Then, a gas mixture of 95% neon and 5% of xenon was injected into the cell as discharge gas, thereby completing manufacture of a PDP.

### Example 2

A PDP according to Example 2 was manufactured in the same manner as in Example 1, except that the amount of the blue phosphor was adjusted to 10 parts by weight, based on a combined 100 parts by weight of the green phosphor and the blue phosphor.

### Example 3

A PDP according to Example 3 was manufactured in the same manner as in Example 1, except that the amount of the blue phosphor was adjusted to 15 parts by weight, based on a combined 100 parts by weight of the green phosphor and the blue phosphor.

### Example 4

A PDP according to Example 4 was manufactured in the same manner as in Example 1, except that the amount of the blue phosphor was adjusted to 20 parts by weight, based on a combined 100 parts by weight of the green phosphor and the blue phosphor.

### Comparative Example

A PDP according to a comparative example was manufactured in the same manner as in Example 1, except that a blue phosphor was not added.

### Evaluative Example

Green emission spectrum, color purity, luminance, and efficiency were evaluated for the PDPs manufactured according to the Comparative Example and Examples 1-4. Evaluation of the green emission spectrum, color purity, luminance, and efficiency were performed using a Kr-lamp diode array rapid-scan spectrometer (DARSA system) including a vacuum chamber at 10⁻⁵ torr.

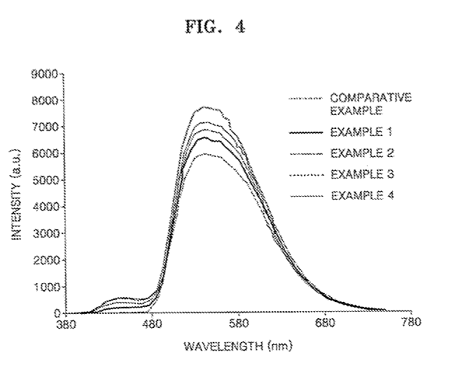

The green emission spectrums of the PDPs manufactured according to the Comparative Example and Examples 1-4 are illustrated in FIG. 4. Referring to FIG. 4, the PDPs manufactured according to the Comparative Example and Examples 1-4 emitted green light having a maximum emission peak of about 540 nm.

The color coordinates and luminance of the PDPs manufactured in the Comparative Example and Examples 1-4 are illustrated in Table 1 below.

TABLE 1

| | Amount of | | | | |
|---|---|---|---|---|---|
| | blue | | | | |
| | phosphor¹ | | | Lumi- | Effi- |
| Example | (parts by | x | y | nance | ciency² |
| Nos. | weight) | coordinate | coordinate | (L, cd/m²) | (%) |
| Comparative | 0 | 0.380 | 0.460 | 280 | 100 |
| Example | | | | | |
| Example 1 | 5 | 0.369 | 0.458 | 305 | 109 |
| Example 2 | 10 | 0.357 | 0.448 | 319 | 114 |
| Example 3 | 15 | 0.346 | 0.441 | 350 | 125 |
| Example 4 | 20 | 0.334 | 0.435 | 330 | 118 |

¹the amount of blue phosphor (parts by weight) is based on a combined 100 parts by weight of the green phosphor and the blue phosphor
²efficiencies of the PDPs manufactured according to the Examples 1-4 are represented as relative values when the efficiency of PDP manufactured according to the Comparative Example is 100%.

According to Table 1, emission efficiencies of the PDPs manufactured according to the Examples 1-4 were improved, compared with that of the Comparative Example.

The phosphor layer described above may be a green phosphor layer having excellent color coordinates and emission efficiency so that the PDP including such phosphor layer may provide improved image quality.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A plasma display panel (PDP) comprising:
a first substrate and a second substrate facing the first substrate;
a phosphor layer disposed in a discharge space interposed between the first substrate and the second substrate;
a discharge electrode applying voltage causing discharge in the discharge space; and
discharge gas injected into the discharge space,
wherein the phosphor layer comprises a first phosphor and a second phosphor, the first phosphor being excited by a first radiation having a wavelength of 147±10 nm, a second radiation having a wavelength of 173±10 nm, and a third radiation having a wavelength within the first wavelength range, and the second phosphor has a maximum emission peak in the first wavelength range.

2. The PDP of claim 1, wherein the first wavelength range is about 300 nm to about 500 nm.

3. The PDP of claim 1, wherein the first phosphor is a YAG:Ce based green phosphor.

4. The PDP of claim 3, wherein the first phosphor is an Y₃Al₅O₁₂:Ce³⁺ green phosphor.

5. The PDP of claim 1, wherein the first phosphor is excited by radiation emitted from the second phosphor.

6. The PDP of claim 1, wherein the maximum emission peak of the radiation emitted from the second phosphor is in a range of about 380 nm to about 480 nm.

7. The PDP of claim 6, wherein the maximum emission peak of the radiation emitted from the second phosphor is in a range of about 430 nm to about 480 nm.

8. The PDP of claim 7, wherein the second phosphor is a BAM based phosphor or a CMS based phosphor.

9. The PDP of claim 8, wherein the second phosphor is one selected from the group consisting of BaMgAl₁₀O₁₇:Eu, BaMgAl₁₄O₂₃:Eu, BaMg₂Al₁₆O₂₇:Eu, and CaMgSi₂O₆:Eu

10. The PDP of claim 1, wherein the amount of the second phosphor is 5 parts by weight to 20 parts by weight based on 100 parts by weight of the total amount of the first phosphor and the second phosphor.

11. The PDP of claim 10, wherein the amount of the second phosphor is 10 parts by weight to 15 parts by weight based on 100 parts by weight of the total amount of the first phosphor and the second phosphor.

12. The PDP of claim 1, wherein the phosphor layer emits green light.

13. The PDP of claim 1, wherein the discharge gas emits vacuum ultraviolet having a wavelength of 147±10 nm and a wavelength of 173±10 nm.

14. A method of manufacturing a plasma display panel (PDP), the method comprising:
formulating a composition for forming a phosphor layer comprising a first phosphor, a second phosphor, a binder, and a solvent, wherein the first phosphor is excited by a first radiation having a wavelength of 147±10 nm, a second radiation having a wavelength of 173±10 nm, and a third radiation having a wavelength within the first wavelength range and the second phosphor has a maximum emission peak in the first wavelength range;
placing the composition for forming the phosphor layer in a discharge space interposed between a first substrate and a second substrate; and
heat treating the supplied composition for forming the phosphor layer and thus forming a phosphor layer in the discharge space.

15. The method of claim 14, wherein the first wavelength range is about 300 nm to about 500 nm.

16. The method of claim 14, wherein the first phosphor is a YAG:Ce based green phosphor.

17. The method of claim 14, wherein the maximum emission peak of the radiation emitted from the second phosphor is in a range of about 430 nm to about 480 nm.

18. The method of claim 14, wherein the second phosphor is a blue phosphor.

19. The method of claim 14, wherein the maximum emission peak of the radiation emitted from the second phosphor is in a range of about 430 nm to about 480 nm.
